(19) United States
(12) Patent Application Publication
(10) Pub. No.: US 2012/0013206 A1
(43) Pub. Date: Jan. 19, 2012

(54) Cooling System and Method for an Electric Machine Module

(76) Inventor: Andrew Meyer, Fishers, IN (US)

(21) Appl. No.: 13/186,334

(22) Filed: Jul. 19, 2011

Related U.S. Application Data
(60) Provisional application No. 61/365,654, filed on Jul. 19, 2010.

(51) Int. Cl. H02K 9/19; H02K 15/00

(52) U.S. Cl. 310/54; 29/596

(57) ABSTRACT

Embodiments of the invention provide an electric machine module including an electric machine. The electric machine includes a rotor assembly. The machine includes an output shaft having a longitudinal axis that is circumscribed by a portion of the rotor assembly. The output shaft comprises an output shaft channel and is coupled to the rotor assembly. A coolant passage system is positioned within the rotor assembly and includes an inlet channel in fluid communication with the output shaft channel and at least one recess. The recess is in fluid communication with the inlet channel. The coolant system can include an outlet channel in fluid communication with the recess. The outlet channel can include at least one coolant outlet so that the coolant outlet is a greater radial distance form the longitudinal axis than is the output shaft channel.

### RELATED APPLICATIONS

This application claims priority under 35 U.S.C. §119 to U.S. Provisional Patent Application No. 61/365,654 filed on Jul. 19, 2010, the entire contents of which is incorporated herein by reference.

### BACKGROUND

Some electric machines include a stator assembly and a rotor assembly and are housed within a machine cavity. Some electric machines are cooled by circulating a coolant through portions of the machine cavity. For example, the coolant can contact the rotor assembly at a generally low tangential speed and then can be accelerated by a combination of friction with the rotor assembly and radial movement further from a center line of rotation of the rotor assembly. Acceleration of the coolant to rotor speeds can result in energy loss on some rotation-based electric machines, such as, but not limited to high speed and large diameter machinery. For example, the acceleration of the coolant requires energy, which can draw energy from the rotor assembly and lead to slowing of the electric machine. For some electric machines, additional energy may need to be added to maintain the speed of the rotor assembly.

### SUMMARY

Some embodiments of the invention provide an electric machine module including an electric machine. The electric machine can include a rotor assembly. The electric machine can include an output shaft including a longitudinal axis that can be at least partially circumscribed by the rotor assembly. In some embodiments, the output shaft comprises an output shaft channel and can be operatively coupled to the rotor assembly. In some embodiments, a coolant passage system can be positioned within the rotor assembly and can include an inlet channel in fluid communication with the output shaft channel. In some embodiments, the coolant passage system can include at least one chamber. In some embodiments, the recess can be in fluid communication with the inlet channel. In some embodiments, the coolant passage system can include an outlet channel in fluid communication with the recess. In some embodiments, the outlet channel can include at least one coolant outlet configured and arranged so that the coolant outlet is a greater radial distance from the longitudinal axis than is the output shaft channel.

Some embodiments of the invention provide an electric machine module, which can include a housing. In some embodiments, the housing can define at least a portion of a machine cavity. In some embodiments, an electric machine can be positioned within the machine cavity and at least partially enclosed by the housing. In some embodiments, the electric machine can include a rotor assembly that can substantially radially oppose a stator assembly. In some embodiments, the rotor assembly can include a rotor hub, which can include at least an inner diameter. In some embodiments, the rotor hub can also comprise an inlet channel in fluid communication with a coolant inlet, which can be in fluid communication with the machine cavity. The rotor hub can include at least one recess in fluid communication with the inlet channel and an outlet channel. In some embodiments, the outlet channel can be in fluid communication with a coolant outlet, which can be in fluid communication with the machine cavity. In some embodiments, the module can comprise an output shaft that can include a longitudinal axis and to which the rotor hub can be operatively coupled. In some embodiments, the coolant inlet can be a first radial distance from the longitudinal axis and the coolant outlet can be a second radial distance from the longitudinal axis so that the first radial distance is less than the second radial distance.

### DESCRIPTION OF THE DRAWINGS

FIG. 1 is a cross-sectional view of an electric machine module according to one embodiment of the invention.

FIG. 2 is a partial cross-sectional view of the electric machine module of FIG. 1.

FIG. 3 is a side view of a rotor lamination according to one embodiment of the invention.

FIG. 4 is a cross-sectional view of an electric machine module according to one embodiment of the invention.

FIG. 5 is a cross-sectional view of an electric machine module according to one embodiment of the invention.

FIG. 6 is a cross-sectional view of an electric machine module according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention.

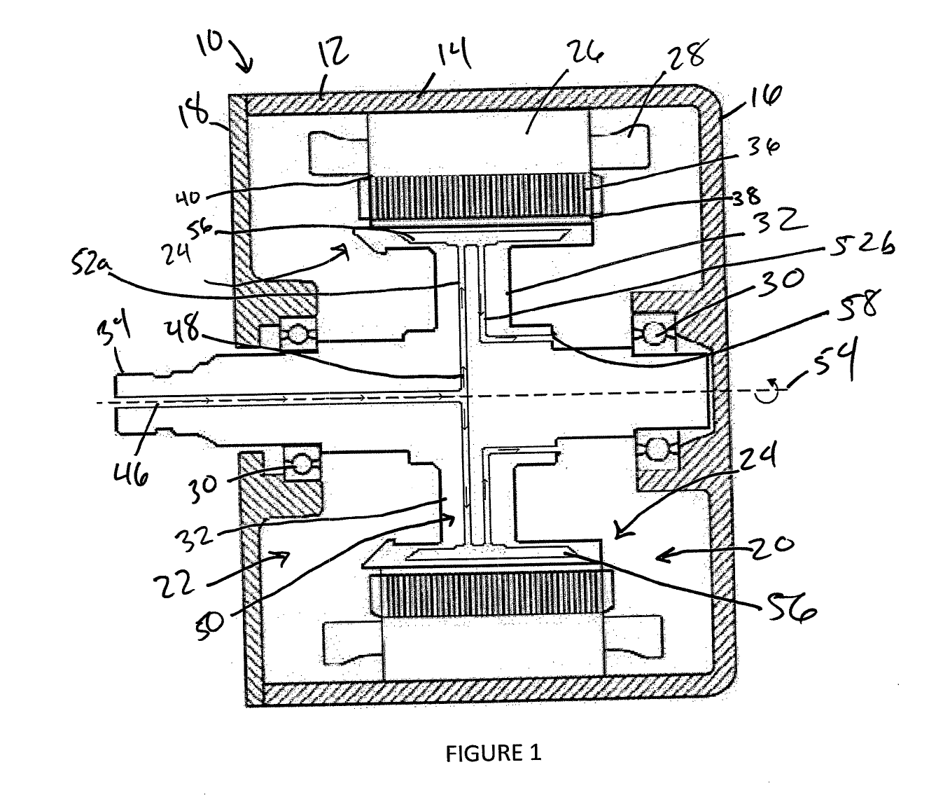

FIG. 1 illustrates an electric machine module 10 according to one embodiment of the invention. The module 10 can include a housing 12 comprising a sleeve member 14, a first end cap 16, and a second end cap 18. An electric machine 20 can be housed within a machine cavity 22 at least partially defined by the an inside wall 17 of portions of the housing 12. For example, the sleeve member 14 and the end caps 16, 18 can be coupled via conventional fasteners (not shown), or another suitable coupling method, to enclose at least a portion of the electric machine 20 within the machine cavity 22. In some embodiments the housing 12 can comprise a substantially cylindrical canister and a single end cap (not shown). Further, in some embodiments, the housing 12, including the sleeve member 14 and the end caps 16, 18, can comprise materials that can generally include thermally conductive properties, such as, but not limited to aluminum or other metals and materials capable of generally withstanding operating temperatures of the electric machine. In some embodiments, the housing 12 can be fabricated using different methods including casting, molding, extruding, and other similar manufacturing methods.

The electric machine 20 can be, without limitation, an electric motor, such as a hybrid electric motor, an electric generator, a vehicle alternator, and/or an induction belt-driven alternator-starter (BAS). In one embodiment, the electric machine 20 can be a High Voltage Hairpin (HVH) electric motor or an interior permanent magnet electric motor for hybrid vehicle applications.

The electric machine 20 can include a rotor assembly 24, a stator assembly 26, including stator end turns 28, and bearings 30, and can be disposed about an output shaft 34. As shown in FIG. 1, the stator 26 can substantially circumscribe a portion of the rotor assembly 24. In some embodiments, the electric machine 20 can also include a rotor hub 32 or can have a “hub-less” design (not shown).

Components of the electric machine 20 such as, but not limited to, the rotor assembly 24, the stator assembly 26, and the stator end turns 28 can generate heat during operation of the electric machine 20. These components can be cooled to increase the performance and the lifespan of the electric machine 20.

In some embodiments, the rotor assembly 24 can be operatively coupled to the output shaft 34 so that the two elements can substantially synchronously move together. In some embodiments, the output shaft 34 can comprise a plurality of splines (not shown) configured and arranged to engage a plurality of splines (not shown) on the rotor hub 32. In some embodiments, the engagement of the splines can at least partially lead to coupling of the rotor assembly 24 and the output shaft 34. For example, in some embodiments, during operation of the electric machine 20, when the output shaft splines are engaged with the rotor hub splines, torque generated by the electric machine 20 can be transferred from the rotor assembly 24 to the output shaft 34. In some embodiments, the output shaft 34 can be operatively coupled to a positive stop (not shown) on the rotor hub 32 to transfer torque. In some embodiments, the output shaft 34 can be operatively coupled to the positive stop on the rotor hub 32 using a bolt (not shown) or another conventional fastener. Moreover, in some embodiments, the output shaft 34 can comprise a male-configured spline set and in other embodiments, the output shaft 34 can comprise a female-configured spline set.

As shown in FIGS. 1-6, in some embodiments, the rotor assembly 24 can comprise a plurality of rotor laminations 36. In some embodiments, the rotor laminations 36 can comprise a plurality of generally annular-shaped structures configured and arranged to be coupled to at least a portion of the rotor hub 32. In some embodiments, the rotor laminations 36 can comprise other shapes that are capable of engaging the rotor hub 32 (e.g., so that the shapes of the two elements are substantially similar). In some embodiments, each of the rotor laminations 36 can comprise an inner diameter 38 and an outer diameter 40 and can be coupled together to form at least a portion of the rotor assembly 24.

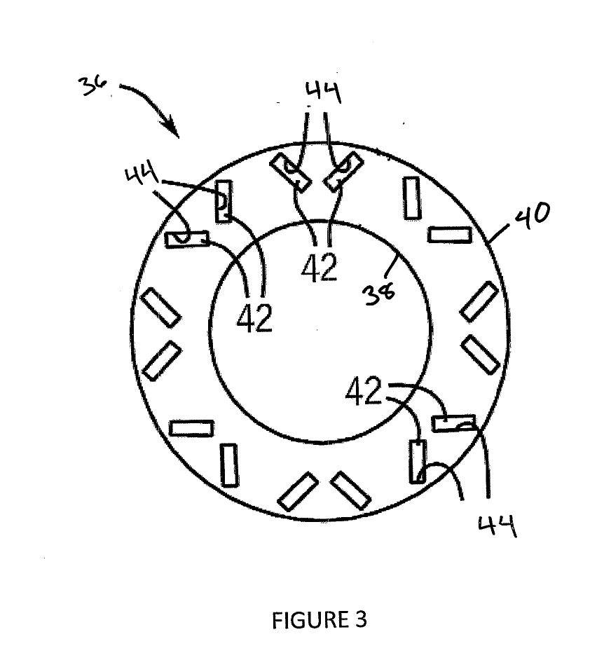

In some embodiments, as shown in FIG. 3, the rotor laminations 36 can comprise multiple elements. In some embodiments, at least a portion of the laminations 36 can include a plurality of apertures 42 that are configured and arranged to support at least a portion of a plurality of magnets 44. For example, in some embodiments, after assembling the laminations 36 to form at least a portion of the rotor assembly 24, the apertures 42 can substantially align in a generally axial direction so that the magnets 44 can be positioned within the rotor assembly 24 in a substantially axial direction. Moreover, in some embodiments, the magnets 44 can be disposed of within the rotor assembly 24 so that at least a portion of the magnets 44 are not substantially axially aligned.

In some embodiments, as shown in FIGS. 1-6, the electric machine module 10 can be configured and arranged to enable a coolant to flow through at least a portion of the module 10. In some embodiments, the coolant can be dispersed from a point generally radially central with respect to the electric machine module 10. In some embodiments, the coolant can comprise a number of substances, including, but not limited to transmission oil, motor oil, another oil, or a mist, a fog, a gas, or another substance. In some embodiments, a coolant source (not shown) can be located either internal or adjacent to the output shaft 34 so that the coolant can flow either inside of or adjacent to the output shaft 34. Moreover, in some embodiments, the coolant source can be at least partially pressurized to impart at least some force upon the coolant. For example, in some embodiments, the output shaft 34 can include at least one output shaft channel 46 and at least one output shaft coolant outlet 48 so that the coolant can flow through the channel 46 and at least a portion of the coolant can exit the output shaft channel 46 through the output shaft coolant outlet 48. In some embodiments, the output shaft coolant outlet 48 can comprise a plurality of output shaft coolant outlets 48. Furthermore, in some embodiments, more than one output shaft coolant outlet 48 can be included. Also, in some embodiments, output shaft coolant outlets 48 can be positioned along the axial length of the output shaft 40 so that the coolant can be dispersed to different areas of the module 10 and machine cavity 22, including the bearings 30. In some embodiments, the output shaft coolant channels 46 can comprise both axially oriented and radially oriented sections so that the module 10 can function without the output shaft coolant outlet 48.

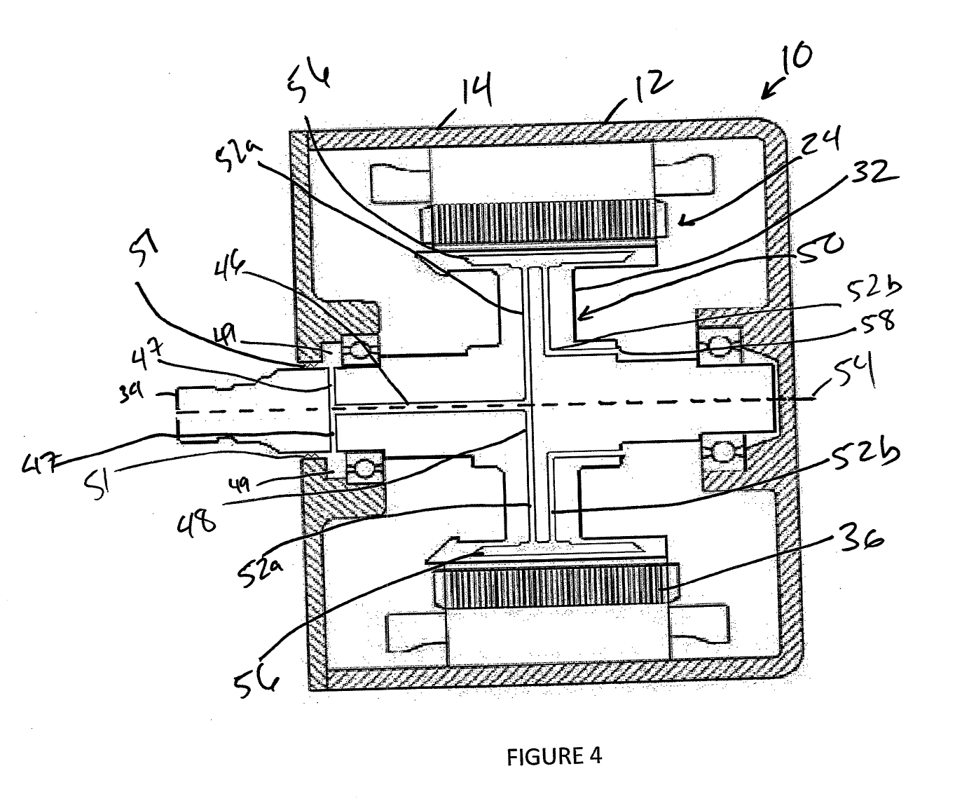

In some embodiments, the output shaft 34 can comprise at least one output shaft inlet channel 47. The output shaft 34 can comprise a plurality of inlet channels 47 in some embodiments as shown in FIG. 4. In some embodiments, at least a portion of the coolant can be circulated from and/or through the housing 12 (e.g., via an inlet (not shown) fluidly connected to a coolant source) to a coolant reservoir 49 substantially adjacent to an axial end of the housing 12 and the bearings 30. In some embodiments, the coolant reservoir 49 can substantially circumscribe at least a portion of the output shaft 34 and can be defined by at least the bearings 30 and portions of the housing 12. Moreover, in some embodiments, at least a portion of the coolant reservoir 49 can be at least partially defined by a seal 51. For example, in some embodiments, the seal 51 can be positioned between the outer diameter of the output shaft 34 and a portion of the housing 12 to substantially prevent any material amounts of coolant from passing from the coolant reservoir 49 to the environment surrounding the module 10. In some embodiments, the seal 51 can comprise any structure capable of sealing the coolant reservoir 49 (e.g., an o-ring). Additionally, although the coolant reservoir 49 is depicted on only one axial side of the module 10, the coolant reservoir 49 can be positioned on either or both axial sides of the module 10.

In some embodiments, coolant can enter the output shaft channel 46 via the inlet channel 47. For example, in some embodiments, at least a portion of the coolant in the coolant reservoir 49 can enter at least one inlet channel 47 under at least some pressure. In some embodiments, at least a portion of the coolant can enter at least one output shaft channel 46 and can proceed to flow through the module 10 as previously mentioned and described below.

In some embodiments, the rotor assembly 24 can include a coolant passage system 50. In some embodiments, the coolant passage system 50 can comprise multiple configurations. In some embodiments, the coolant passage system 50 can comprise at least one channel 52 that can be configured and arranged to carry at least a portion of the coolant. In some embodiments, the coolant passage system 50 can comprise a plurality of channels 52, as will be described in further detail below. In some embodiments, the channels 52 can be substantially radially oriented so that the channels 52 can extend from a substantially radially inner portion of the rotor assembly 24 (e.g., from a point substantially adjacent to an inner diameter of the rotor assembly 24) in a generally radially outward direction so that the channels 52 are substantially perpendicular to a longitudinal axis 54 (e.g., a center axis of rotation of the electric machine 20) of the output shaft 34. In some embodiments, the channels 52 can extend in a plurality of radially outward directions. For example, in some embodiments, the channels 52 can extend in regular or irregular patterns from points substantially adjacent to a generally radially inner portion of the rotor assembly 24 (e.g., channels 52 extending radially outward at “12 o'clock,” “3 o'clock,” “6 o'clock,” etc. positions and/or spokes of a wheel).

In some embodiments, the coolant passage system 50 can comprise a rotor coolant recess 56. In some embodiments, the recess 56 can be positioned substantially radially outward relative to the output shaft 34 and substantially within the rotor assembly 24. In some embodiments, the recess 56 can be substantially annular and can extend around an inner circumference of the rotor assembly 24 (e.g., the recess 56 can be positioned substantially radially inward from an outer diameter of the rotor assembly 24). In some embodiments, the recess 56 can comprise other shapes and can extend a distance less than the entire inner circumference of the rotor assembly 24. Moreover, in some embodiments, the coolant passage system 50 can comprise a plurality of recesses 56. For example, the system 50 can include multiple recesses 56 positioned at multiple radial distances from the output shaft 34 and positioned at different circumferential positions throughout the rotor assembly 24. Additionally, in some embodiments, at least one recess 56 can be positioned substantially adjacent to at least a portion of the magnets 44. For example, in some embodiments, the recess 56 can be in thermal communication with at least a portion of the magnets 44.

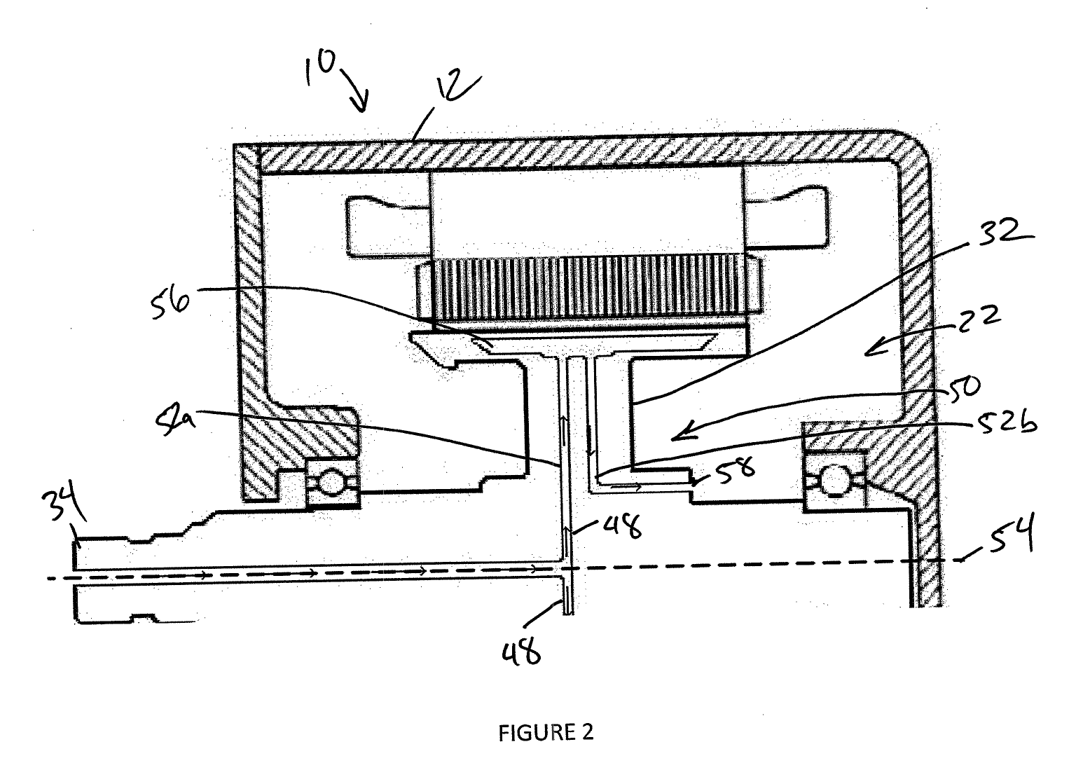

In some embodiments, at least one channel 52 can fluidly connect at least one recess 56 to at least one output shaft coolant outlet 46. As shown in FIGS. 1 and 2, in some embodiments, the channel 52 can be in fluid communication with both the output shaft coolant outlet 46 and the recess 56. As a result, in some embodiments, at least a portion of the coolant can enter the output shaft coolant channel 46, flow through the output shaft coolant outlet 48, and enter the channel 52. In some embodiments, the coolant can be at least partially pressurized, which can lead to coolant flow through the channels 46, 52 and the outlet 48. Moreover, in some embodiments, the radially outward directed flow of at least a portion of the coolant through the channels 52 can be at least partially driven by the operation of the electric machine 20. For example, in some embodiments, the rotor assembly 24 substantially rotates in a circumferential direction about the output shaft 34, which can produce at least some centrifugal force. As a result, in some embodiments, at least a portion of the coolant can be drawn radially outward through at least some of the channels 52. Additionally, in some embodiments, multiple channels 52 can be in fluid communication with multiple output shaft coolant outlets 48 (e.g., one channel 52 per outlet 48, multiple channels 52 per outlet 48, and/or one channel 52 per multiple outlets 48).

In some embodiments, at least a portion of the coolant flowing through the channels 52 can enter at least one recess 56. As previously mentioned, in some embodiments, at least a portion of the coolant can flow radially outward through the channels 52 via pressure and/or centrifugal force associated with the movement of the rotor assembly 24. As a result, at least a portion of the coolant can reach the recess 56. Although, in some embodiments, the coolant can be circulated to a plurality of recesses 56. In some embodiments, the coolant can circulate through at least a portion of the recess 56 to receive at least a portion of the heat energy produced by the rotor assembly 24. For example, in some embodiments, as some of the coolant flows through the recess 56 or recesses 56, the coolant can receive at least a portion of the heat energy produced by the magnets 44. As a result, by at least partially cooling the magnets 44, the risk of demagnetization can be at least partially reduced.

In some embodiments, the coolant passage system 50 can comprise at least one inlet channel 52a and at least one outlet channel 52b. For example, in some embodiments, the inlet channel 52a can fluidly connect the output shaft coolant outlet 48 and at least one of the recesses 56, as previously mentioned. And, in some embodiments, the outlet channel 52b can be configured and arranged to direct at least a portion of the coolant from at least some of the recesses 56 to another location, as will be described below. In some embodiments, the coolant passage system 50 can comprise about the same number of channels 52a, 52b and in other embodiments, the coolant passage system 50 can comprise greater or lesser numbers of inlet channels 52a relative to outlet channels 52b.

In some embodiments, at least a portion of the coolant can exit the recesses 56 via at least one outlet channel 52b. In some embodiments, at least a portion of the coolant can flow from at least some of the recesses 56 radially inward through the outlet channel 52b. In some embodiments, portions of the coolant can circulate through a plurality of outlet channels 52b. Additionally, in some embodiments, the outlet channel 52b can comprise both radially oriented and axially oriented sections. In some embodiments, at least some of the outlet channels 52b can fluidly connect at least some of the recesses 56 with the machine cavity 22 and other elements of the module 10. For example, as shown in FIGS. 1, 2, 4, and 5, in some embodiments, the outlet channel can extend radially inward and axially outward from the recess 56. As a result, in some embodiments, at least a portion of the coolant can flow through the outlet channel 52b and can enter the machine cavity 22 where it can contact at least a portion of the adjacent elements of the module 10. Moreover, in some embodiments, as the coolant circulates through the coolant passage system 50, it can receive at least a portion of the heat energy produced by any other portions of the rotor assembly 24, including the magnets 44, as previously mentioned.

In some embodiments, at least a portion of the outlet channels 52b can be in fluid communication with the machine cavity 22. In some embodiments, the coolant passage system 50 can comprise at least one outlet 58 to fluidly connect the outlet channel 52b to the machine cavity 22. For example, in some embodiments, the outlet 58 can be disposed through a generally axially outward portion of the rotor assembly 24 and can be configured and arranged so that at least a portion of the coolant can be directed axially outward from the outlet 58, as reflected by the arrows in FIGS. 1 and 2. Moreover, in some embodiments, the rotor assembly 24 can comprise a plurality of outlets 58.

Additionally, in some embodiments, the outlet 58 can be disposed radially outward from where the coolant initially flows radially outward. For example, in some embodiments, the coolant can begin to flow radially outward (e.g., enter the output shaft coolant outlets 48 and/or the inlet channels 52a) at a point substantially adjacent to the longitudinal axis 54, as shown in FIGS. 1 and 2. In some embodiments, the outlet 58 can be positioned more radially outward from the longitudinal axis 54 than is the output shaft coolant channel 46 (e.g., either below or above the longitudinal axis 54 of the output shaft 34), which can impact the flow of the coolant, as described below.

As a result, in some embodiments, the differential in radial positioning can at least partially mediate the coolant flow through the coolant passage system 50. In some embodiments, the difference in radial distance can at least partially function as a pumping pressure differential that can provide at least a portion of the force causing the coolant to flow. By way of example only, the coolant can begin to flow radially outward at a relatively low or zero tangential speed relative to the rotor assembly 24 (e.g., a point substantially radially centrally located). The coolant can accelerate as it circulates through the inlet channel 52a away from the output shaft coolant outlet 48 by a combination of friction with the rotor assembly 24 and radial movement further from the longitudinal axis 54. Then, the coolant can flow radially inward through the outlet channel 52b and decelerate until reaching the outlet 58, where the speed of the coolant will substantially correlate with the distance from where the coolant began flowing radially outward. As a result, in some embodiments, the coolant can exit the outlet 58 at relatively low tangential speeds and energy losses of the electric machine 20 can be minimized due to the coolant decelerating prior to exiting the coolant passage system 50. Moreover, in some embodiments, some modules 10 can be configured and arranged with outlets 58 in different locations so that coolant flow rates can be varied. For example, in some embodiments, a lesser radial distance differential can lead to a lesser coolant flow rate as a portion of the coolant exits the outlet 58, which can lead to at least partially enhanced control over coolant flow.

In some embodiments, the location of the outlet 58 can substantially prevent or minimize exhausting coolant from pooling or splashing near undesired locations. For example, some conventional electric machines expel some coolant near the outer radial edges of the rotor assembly 24, which can lead to introduction of the coolant in an air gap defined between the rotor assembly 24 and the stator assembly 26. This can cause excessive electric machine 20 losses due to viscous shearing of the coolant between the rotating rotor assembly 24 and the stationary stator assembly 26.

In some embodiments, the coolant passage system 50 can be constructed in different manners. As previously mentioned, in some embodiments, the rotor assembly 24 can comprise a rotor hub 32. In some embodiments, as shown in FIG. 1, the rotor hub 32 can comprise a substantial portion of the coolant passage system 50, including, but not limited to the channels 52a, 52b and the recesses 56. In some embodiments, the coolant passage system 50 can be substantially integral with the rotor hub 32. In some embodiments, the rotor hub 32 can be cast from a material (e.g., steel, aluminum, other metals and/or polymers), machined, molded, or fabricated in other manners. By way of example only, in some embodiments, the rotor hub 32 can be cast from aluminum and the casting process can be configured so that the rotor hub 32 is cast around a mold that will create at least a portion of the coolant passage system 50 within the rotor hub 32 after casting.

In addition, in some embodiments, the hubless configuration of the rotor assembly 24 also can be configured and arranged to include the coolant passage system 50. In some embodiments, in order to include the coolant passage system 50 in the rotor assembly 24 with a hubless configuration, the laminations 36 can be configured and arranged to define at least a portion of the coolant passage system 50. In some embodiments, at least some of the laminations 36 can be formed (e.g., stamped) and then assembled in a manner to define at least a portion of the coolant passage system 50. By way of example only, in some embodiments, at least a portion of the plurality of laminations 36 can be formed so that that some of the laminations 36 include portions of the system 50 and the laminations 36 can then be indexed and coupled together so that the system 50 is substantially integral with the rotor assembly 24.

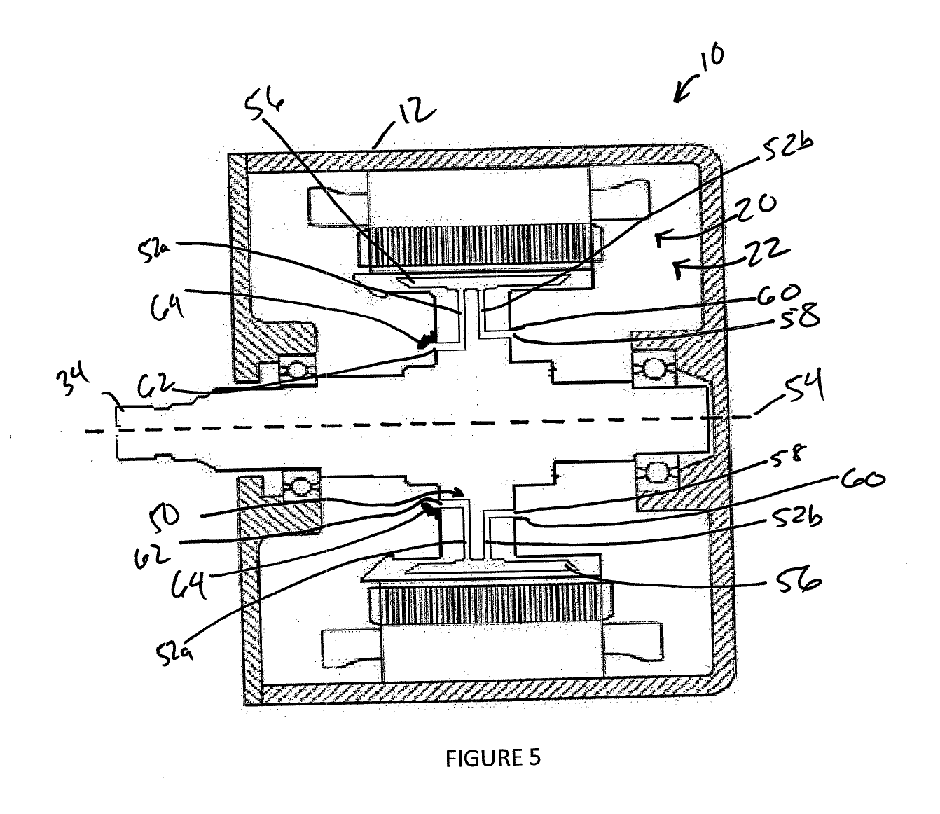

Moreover, in some embodiments, the module 10 can comprise multiple cooling configurations. For example, in some embodiments, as shown in FIG. 5, a catch 60 can be coupled to the rotor assembly 24 substantially adjacent to the outlet 58. In some embodiments, the catch 60 can be immediately adjacent to and/or coupled to the outlet 58. In some embodiments, the module 10 can comprise a plurality of catches 60 (e.g., one or more catches 60 per outlet 58). Also, in some embodiments, the catch 60 can comprise a polymer, aluminum, other metal, or other material and can be molded to suit end-user needs.

In some embodiments, the catch 60 can be configured and arranged to direct, guide, and/or urge at least a portion of the coolant in a desired direction. For example, in some embodiments, the catch 60 can be coupled to the rotor assembly 24 and can axially and/or radially extend a distance into the machine cavity 22. Although, in some embodiments, the catch 60 can be coupled to other portions of the module 10, such as the housing 12, the output shaft 34, or other portions of the electric machine 12. In some embodiments, the catch 60 can substantially direct at least a portion of the coolant toward a coolant sump, drain, or other desired location (not shown). Accordingly, in some embodiments, the catch 60 can at least partially prevent and/or minimize coolant pooling or splashing near undesired locations in the machine cavity 22, as previously mentioned. Moreover, in some embodiments, the catch 60 can at least partially prevent coolant from being slung radially outward (e.g., toward the stator end turns 28). In some embodiments, by preventing and/or reducing the radial slinging of coolant, energy losses associated with coolant contacting some of the elements of the electric machine 20 (e.g., the rotor assembly 24) can be at least partially reduced. Further, by reducing radially slinging of some of the coolant, the risk of insulation damage of the stator end turns 28 also can be reduced because less coolant is contacting an insulation layer coupled to an outer perimeter of portions of the stator end turns 28 for electrical and mechanical insulation purposes.

Further, in some embodiments, the coolant passage system 50 can comprise other configurations. As shown in FIG. 5, in some embodiments, the coolant passage system 50 can function without at least some of the outlet shaft coolant channels 46 and the outlet shaft coolant outlets 48. For example, in some embodiments, the coolant passage system 50 can comprise an inlet 62 disposed on an axial side of the rotor assembly 24 substantially opposing the outlet 58, although in some embodiments, the inlet 62 and the outlet 58 can be on the same axial side. In some embodiments, the inlet 62 can fluidly connect the machine cavity 22 with at least some of the inlet channels 52a. Moreover, in some embodiments, multiple inlets 62 can fluidly connect multiple inlet channels 52a to the machine cavity 22. In some embodiments, the inlets 62 can be configured to receive coolant from the machine cavity 22 so that the coolant can enter the inlet channels 52a and then flow through the recess 56, the outlet channel 52b and then re-enter the machine cavity 22 via the outlet 58. In some embodiments, relative to the outlet 58, the inlet 62 can be positioned radially inwardly, which can result in the pump pressure differential, as previously described. For example, in some embodiments, the inlet 62 can be positioned a first radial distance from the longitudinal axis 54 and the outlet 58 can be positioned a second radial distance from the longitudinal axis 54 and the first radial distance can be lesser than the second radial distance.

In some embodiments, a guide 64 can be positioned substantially adjacent to at least some of the inlets 62. For example, as shown in FIG. 5, in some embodiments, the guide 64 can be coupled to the rotor assembly 24 adjacent to the inlet 62 and can axially and/or radially extend a distance into the machine cavity 22. Although, in some embodiments, the guide 64 can be coupled to other portions of the module 10, such as the housing 12, the output shaft 34, or other portions of the electric machine 12. In some embodiments, the guide 64 can be configured and arranged to guide coolant from the machine cavity 22 into the coolant passage system 50. For example, as disclosed in U.S. patent application Ser. No. 13/101,049, which is herein incorporated by reference, the housing 12 can be configured and arranged so that coolant can be dispersed from walls of the housing 12 substantially axially adjacent to the rotor assembly 24. As a result, in some embodiments, at least a portion of the coolant can be guided into the inlet channel 52a via the inlet 62 and the guide 64 so that the coolant contacts only limited elements of the electric machine 20 to at least partially reduce energy losses, as previously mentioned.

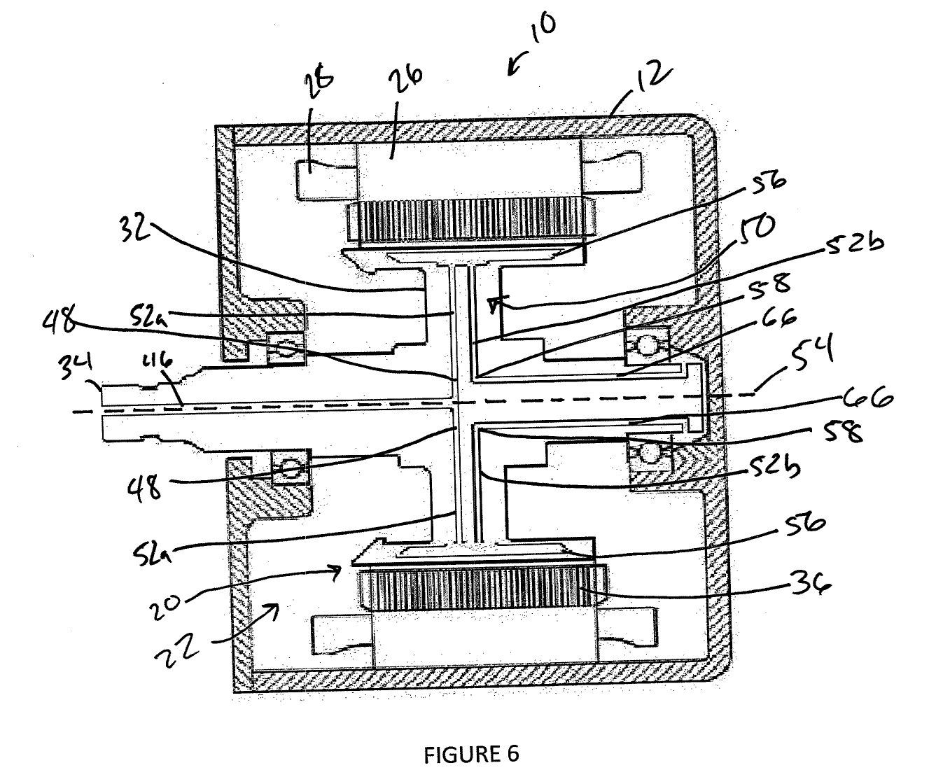

As shown in FIG. 6, in some embodiments of the invention, the coolant can flow through a substantially sealed system. For example, as show in FIG. 6, in some embodiments, the output shaft 34 can comprise at least one exhaust channel 66, although in some embodiments, the output shaft 34 can comprise a plurality of exhaust channels 66. In some embodiments, the coolant outlets 58 can fluidly connect the outlet channels 52b to at least some of the exhaust channels 66. Moreover, in some embodiments, the coolant outlets 58 can fluidly connect the outlet channels 52b to at least some of the exhaust channels 66 at a point substantially radially outward relative to the output shaft coolant channel 46. As a result, in some embodiments, the differential in radial distance between where the coolant begins to flow radially outward and where the outlet channels 52b and the exhaust channels 66 fluidly connect can create a pumping pressure differential, which can at least partially urge the coolant through the coolant passage system 50.

In some embodiments, the exhaust channels 66 can at least partially prevent coolant from entering the machine cavity 22 and contacting some elements of the module 10. As shown in FIG. 6, in some embodiments, at least a portion of the exhaust channels 66 can be configured and arranged to direct at least a portion of the coolant out of the module 10. In some embodiments, the exhaust channels 66 can axially extend from a point where the channels 66 fluidly connect to the outlet channels 52b through at least a portion of the output shaft 34. Moreover, in some embodiments, at least a portion of the exhaust channels 66 can be in fluid communication with a drain system (not shown). For example, in some embodiments, the drain system can be coupled to and/or positioned substantially within portions of the housing 12 and can be configured and arranged to guide coolant from the exhaust channels 66 to remote location. In some embodiments, the drain system can be fluidly connected to a heat exchange element so that at least a portion of the heat energy received by the coolant can be removed and the coolant can be recycled for further cooling.

In some embodiments, by flowing at least a portion of the coolant through the exhaust channels 66, electric machine 20 energy loss can be at least partially reduced. As previously mentioned, coolant entering the machine cavity 22 and entering the air gap or contacting moving elements of the module 10 can lead to at least a partial energy loss by the electric machine 20. In some embodiments, by directing at least a portion of the coolant through the exhaust channels 66 and not into the machine cavity 22, the electric machine 20 energy loss can be at least partially reduced. Moreover, because at least a portion of the coolant flows through the exhaust channels 66 in some embodiments, less coolant can be radially slung, which can at least partially reduce wear on the stator end turn 28 insulation layer.

Additionally, many of the previously mentioned embodiments can be combined to form different cooling configurations of the module 10. For example, in some embodiments, coolant can flow through the substantially sealed system and can be directed to the drain system using at least one catch 60. Similarly, other embodiments can be combined to produce a module 10 that meets end user needs and requirements.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. An electric machine module comprising:
an electric machine including a rotor assembly and a stator assembly, the stator assembly circumscribing at least a portion of the rotor assembly, an air gap at least partially disposed between the rotor assembly and the stator assembly;
an output shaft including a longitudinal axis and comprising at least one output shaft channel; and
the rotor assembly coupled to at least a portion of the output shaft; and
a coolant passage system at least partially disposed within the rotor assembly, the coolant passage system including
at least one inlet channel in fluid communication with the output shaft channel,
at least one chamber disposed within the rotor assembly and being in fluid communication with the at least one inlet channel, and
at least one outlet channel in fluid communication with the at least one recess, the at least one outlet channel including at least one coolant outlet so that the at least one coolant outlet is a greater radial distance from the longitudinal axis than is the at least one output shaft channel.

2. The electric machine module of claim 1 and further comprising at least one catch coupled to the rotor assembly substantially adjacent to the at least one coolant outlet.

3. The electric machine module of claim 2, wherein the at least one catch is configured and arranged to direct at least a portion of a coolant away from the electric machine and the air gap.

4. The electric machine module of claim 1, and further comprising a housing defining at least a portion of a machine cavity and the electric machine at least partially positioned within the machine cavity and at least partially enclosed within the housing.

5. The electric machine module of claim 4, and further comprising at least one coolant reservoir at least partially defined by a portion of the housing and a portion of the output shaft.

6. The electric machine module of claim 5, wherein the output shaft comprises at least one inlet channel disposed to fluidly connect the at least one coolant reservoir and the at least one output shaft channel.

7. The electric machine module of claim 4, wherein the output shaft comprises at least one exhaust channel, the exhaust channel fluidly connected to the at least one outlet channel via the coolant outlet.

8. The electric machine module of claim 7, wherein at least a portion of the at least one exhaust channel is a greater radial distance from the longitudinal axis than is the at least one output shaft channel.

9. The electric machine module of claim 1, wherein the rotor assembly comprises a rotor hub and the rotor hub comprises at least a portion of the coolant passage system.

10. The electric machine module of claim 1, wherein the rotor assembly comprises a hubless configuration.

11. An electric machine module comprising:
a housing defining a machine cavity;
an electric machine positioned within the machine cavity and at least partially enclosed by the housing, the electric machine including a rotor assembly substantially radially opposing a stator assembly, the rotor assembly including a rotor hub, the rotor hub comprising
an inner diameter,
an inlet channel in fluid communication with a coolant inlet, the coolant inlet in fluid communication with the machine cavity,
at least one chamber in fluid communication with the inlet channel, and
an outlet channel in fluid communication with the at least one recess and a coolant outlet, the coolant outlet in fluid communication with the machine cavity; and
an output shaft including a longitudinal axis, the rotor hub operatively coupled to the output shaft at the inner diameter of the rotor hub; and
the coolant inlet located at a first radial distance from the longitudinal axis and the coolant outlet located at a second radial distance from the longitudinal axis, wherein the first radial distance is less than the second radial distance.

12. The electric machine module of claim 11, and further comprising at least one guide coupled to the rotor assembly substantially adjacent to the coolant inlet.

13. The electric machine module of claim 12, wherein the at least one guide is configured and arranged to guide at least a portion of a coolant from the machine cavity through the coolant inlet.

14. The electric machine module of claim 13, wherein the housing is configured and arranged to disperse a volume of coolant in a generally axial direction toward the coolant inlet.

15. The electric machine module of claim 11, and further comprising at least one catch coupled to the rotor assembly substantially adjacent to the coolant outlet.

16. The electric machine module of claim 15, wherein the at least one catch is configured and arranged to direct at least a portion of a coolant away from the electric machine.

17. A method of assembling an electric machine module, the method comprising:
providing a housing, the housing defining at least a portion of a machine cavity;
positioning an electric machine within the machine cavity so that the electric machine is at least partially enclosed within the housing, the electric machine including a rotor assembly, the rotor assembly including an inner diameter;
operatively coupling at least a portion of the rotor assembly to an output shaft including a longitudinal axis;
positioning an output shaft channel substantially within the output shaft;
positioning an inlet channel substantially within the rotor assembly so that the inlet channel radially extends from a point substantially adjacent to the inner diameter of the rotor assembly and the inlet channel is in fluid communication with the output shaft channel;
positioning at least one recess within the rotor assembly so that the at least one recess is in fluid communication with the inlet channel; and
positioning an outlet channel substantially within the rotor assembly and in fluid communication with the at least one recess so that the entire output channel is a greater radial distance from the longitudinal axis of the output shaft than is the output shaft channel.

18. The method of claim 17 and further comprising positioning at least one coolant outlet through a portion of the rotor assembly to fluidly connect the outlet channel and the machine cavity.

19. The method of claim 18 and further comprising coupling at least one catch to the rotor assembly.

20. The method of claim 17 and further comprising providing at least one shaft exhaust channel substantially within the output shaft so that the at least one shaft exhaust channel is in fluid communication with the outlet channel.
